(19) United States
(12) Patent Application Publication
(10) Pub. No.: US 2006/0034388 A1
(43) Pub. Date: Feb. 16, 2006

(54) Data sending device, data receiving device, transmission path encoding method, and decoding method

(76) Inventors: Yuji Mizuguchi, Hirakata (JP); Nobuhiko Yasui, Moriguchi (JP); Noboru Katta, Kawasaki (JP); Takahisa Sakai, Yokohama (JP); Yutaka Takahira, Neyagawa (JP); Hirotsugu Kawada, Osaka (JP); Toshitomo Umei, Settsu (JP); Takashi Akita, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/530,278

(22) PCT Filed: Jan. 28, 2004
(86) PCT No.: PCT/JP04/00746

§ 371 Date: Apr. 5, 2005

(51) Int. Cl. H04L 27/20

(52) U.S. Cl. 375/295

(57) ABSTRACT

A data section is mapped such that the polarity of the signal level of each symbol is constantly inverted on a symbol by symbol basis. On the other hand, a header section is mapped such that the header section includes a distinguishing symbol for distinguishing the data section and the header section from each other, and such that the signal level of the distinguishing symbol is equal to the signal level of the symbol which is mapped immediately before the distinguishing symbol. Thus, data transfer, by which the header section and the data section can be distinguished from each other with certainty by an apparatus on the receiving side, is made possible.

### TECHNICAL FIELD

The present invention relates to a data sending device, a data receiving device, a transmission path encoding method, and a decoding method; and more specifically, to a data sending device, a data receiving device, a transmission path encoding method, and a decoding method for sending or receiving a signal which is generated by mapping each symbol of sending data to any one of a plurality of signal levels.

### BACKGROUND ART

Conventionally, for transferring digital audio data between two apparatuses, biphase mark encoding is generally used as defined by, for example, the format of the S/PDIF (Sony/Philips Digital Interface). According to the biphase mark encoding, as shown in FIG. 18, each bit of original data is represented by two logical values. After the biphase mark encoding, state transition of logic “1” of the original data occurs at the center of a one-bit period (for example, 0→1 or 1→0); and state transition of logic “0” of the original data does not occur even at the center of a one-bit period (for example, 0→0 or 1→1). Moreover, at each border between bits of the original data, the logical value is necessarily inverted (i.e., after the biphase mark encoding, when the immediately previous logical value is 0, that logical value is inverted to 1; and when the immediately previous logical value is 1, that logical value is inverted to 0).

As described above, when biphase mark encoding is used, the logical value is necessarily changed at each border between bits of the original data. Therefore, even when the same logical value 0 or 1 is continued in the original data, an apparatus on the receiving side can easily recover a clock signal from the transferred data without requiring the clock signal to be separately sent.

In general, data which is transferred between apparatuses includes audio data which is biphase-mark-encoded as described above, and an 8-bit preamble (corresponding to the size of 4 bits in the original data before the biphase mark encoding) for synchronizing the audio data added to the audio data. To the preamble, biphase mark encoding is not applied. A bit stream of a preamble includes three or more “0”s or “1“s consecutively. In biphase-mark-encoded data, the logical value is necessarily inverted at each border between bits of the original data as described above. Therefore, the biphase-mark-encoded data never includes three “0”s or “1”s consecutively. For this reason, an apparatus on the receiving side can easily distinguish an audio data section and a preamble section from each other by distinguishing whether three consecutive “0”s or “1”s have been received or not. For a preamble, a plurality of patterns are prepared in advance; for example, a preamble indicating a leading end of a block (B preamble), a preamble indicating a leading end of a sub frame of an R channel (M preamble), and a preamble indicating a leading end of a sub frame of an L channel (W preamble).

According to the S/PDIF, data is transferred on a frame (S/PDIF frame) by frame (S/PDIF frame) basis as shown in FIG. 19, and the above-described biphase mark encoding is applied to the data section. Before the data section, the above-mentioned preamble section (header) is added. FIG. 20 shows a pattern of each header (a B header, an M header, and a W header) utilized in the S/PDIF. Since the sign is necessarily inverted at the border between a header section and a data section of an S/PDIF frame, two patterns corresponding to the immediately previous sign are prepared as the patterns of each header.

FIG. 21 shows a representative structure of a conventional S/PDIF sending and receiving device. A sending and receiving device 90 includes an S/PDIF controller 91, an E/O converter 92, and an O/E converter 93. The S/PDIF controller 91 receives input sending data. The S/PDIF controller 91 performs biphase mark encoding on, and adequately adds a header (a B header, an M header, etc.) to, the sending data, and outputs an S/PDIF frame as shown in FIG. 19 to the E/O converter 92. The E/O converter 92 converts the S/PDIF frame (electric signal) from the S/PDIF controller 91 into an optical signal, and outputs the optical signal to another sending and receiving device via an optical fiber 94. On the other hand, the sending and receiving device 90 receives an input optical signal from another sending and receiving device via an optical fiber 95. The input optical signal is converted into an electric signal via the O/E converter 93 and is input to the S/PDIF controller 91 as an S/PDIF frame as shown in FIG. 19. The S/PDIF controller 91 distinguishes the header type based on the header of the S/PDIF frame, biphase-mark-decodes the data section, and outputs receiving data.

The S/PDIF is a communication protocol optimized for data transfer using a POF (Plastic Optical Fiber), but can also use a conductor such as a twisted pair cable or a coaxial cable as a transmission medium. An advantage of using a conductor is that the conductor is easy to handle.

Data transfer using biphase mark encoding does not need transfer of a clock signal, but requires an increased transfer band for realizing a predetermined data transfer rate. For example, as shown in FIG. 21, in order to realize an effective transfer rate of 25 Mbps, the S/PDIF requires a data transfer rate of 50 Mbps. Accordingly, when biphase-mark-encoded sending data which is output from a vehicle-mounted apparatus or the like is sent to an in-vehicle network as it is, the influence of electromagnetic radiation which is released outside cannot be ignored even when a twisted pair cable is used as a transmission medium which has a low possibility of exerting an influence on the outside.

In order to solve this problem, it is conceivable to map each 2 bits of the sending data which is output from the S/PDIF controller 91 to a predetermined signal level as one symbol for transmission (for example, see PCT International Publication No. 02/30075 pamphlet (FIG. 16 and FIG. 17)).

FIG. 22 shows an exemplary structure of a sending and receiving device for transmitting an S/PDIF frame via a twisted pair cable. In FIG. 22, an S/PDIF frame (serial data) which is output from the S/PDIF controller 91 is converted into parallel data in units of 2 bits by an s/p conversion section 97. An octonary mapping section 98 maps 2-bit data which is sequentially output from the s/p conversion section 97 to a predetermined signal level as one symbol. (More accurately, the octonary mapping section 98 maps each symbol to a change amount from the immediately previous symbol, but this will not be described in detail here.) FIG. 23 shows an exemplary result of processing performed by the octonary mapping section 98. The result of processing performed by the octonary mapping section 98 is converted into an analog signal by a D/A conversion section 99 and then is output to a twisted pair cable 105 via a differential driver 100. Although not shown, the sending and receiving device 96 includes, for example, a digital filter such as a roll-off filter or the like on a stage after the octonary mapping section 98, and also adequately includes an analog filter on, for example, a stage after the D/A conversion section 99.

On the other hand, a differential receiver 104 receives an input signal from another apparatus via a twisted pair cable 106. This receiving signal is input to an A/D conversion section 103 via the differential receiver 104 and is converted into a digital signal. The output data from the A/D conversion section 103 is supplied to an octonary determination section 102, and each symbol is converted into 2-bit parallel data based on the signal level thereof. The parallel data which is output in units of 2 bits from the octonary determination section 102 is converted into serial data by a p/s conversion section 101 and is input to the S/PDIF controller 91. The output from the p/s conversion section 101 corresponds to the S/PDIF frame shown in FIG. 19. The S/PDIF controller 91 outputs receiving data based on the input S/PDIF frame.

As described above, by mapping each 2 bits of the sending data which is output from the S/PDIF controller 91 to a predetermined signal level as one symbol for transmission, the symbol rate can be suppressed to half of the symbol rate in the case where 1 bit is transmitted as one symbol, and thus the electromagnetic radiation can be reduced. As shown in FIG. 23, by performing mapping such that the polarity of the signal level is constantly inverted on a symbol by symbol basis, the sending signal always includes a frequency component which is half of the frequency of the symbol. Therefore, the apparatus on the receiving side can guarantee clock recovery with higher certainty by PLL (Phase Lock Loop).

### DISCLOSURE OF THE INVENTION

However, when 2-bit information is transmitted as one symbol by the mapping shown in FIG. 23, each symbol is mapped to either one of eight signals (hereinafter, such mapping will be referred to as “octonary mapping”), which causes a problem that the interval between thresholds for determining the signal level on the receiving side is narrowed and thus transmission errors easily occur.

Accordingly, in order to solve the above-mentioned problem, the present inventors conceived first returning a data section of an biphase-mark-encoded S/PDIF frame into a pre-biphase mark encoding data stream and then mapping each symbol to any one of four signal levels as shown in FIG. 24 (hereinafter, such mapping will be referred to as “quaternary mapping”) for transmission. Since this can widen the interval between thresholds for determining the signal level as compared to the case with the octonary mapping, without increasing the symbol rate, data transmission with less errors is made possible.

However, it was found that when applying the above-mentioned quaternary mapping to an S/PDIF frame, handling of a header section becomes a problem. In more detail, a header section (8 bits) is not generated as a result of biphase-mark-encoding of the original data and thus cannot be transmitted as 4-bit data. When quaternary mapping is applied to the 8-bit header section for transmission, transfer of the header section requires an 8-symbol period. As a result, the frame cycle of the S/PDIF frame is changed, which causes a problem that the smooth transfer of the S/PDIF frame is hindered. Even if the 8-bit header section is adequately converted into 4-bit data and then transmitted with quaternary mapping applied thereto, it is difficult for the apparatus on the receiving side to distinguish the header section and the data section from each other with certainty because a part of the bit stream of the data section can possibly accidentally match the bit stream of the header section.

Accordingly, the present invention has an object of providing a data sending device, a data receiving device, a transmission path encoding method, and a decoding method capable of allowing an apparatus on the receiving side to distinguish a non-data section which is to be transmitted in a state of being distinguished from a data section, such as, for example, a header section of the above-mentioned S/PDIF frame, from the data section with certainty.

To achieve the above object, the present invention has the following aspects. The reference numerals and the like in the parentheses indicate the correspondence with the embodiments described later in order to help the understanding of the present invention, and do not limit the scope of the present invention in any way.

A transmission path encoding method according to the present invention is for mapping each symbol of sending data to any one of a plurality of signal levels (+1.5, +0.5, −0.5, −1.5). According to this transmission path encoding method, a data section is mapped such that a higher/lower relationship (polarity) of a signal level of each symbol with respect to a reference level (0) is constantly inverted on a symbol by symbol basis. In more detail, the mapping is performed such that: when the signal level of the N'th (N is an arbitrary integer) symbol of the data section is higher than the reference level, the signal level of the next symbol, i.e., the (N+1)th symbol is lower than the reference level; and when the signal level of the N'th symbol in the data section is lower than the reference level, the signal level of the (N+1)th symbol is higher than the reference level. A non-data section to be transmitted in a state of being distinguished from the data section, such as, for example, a header section, is mapped such that the non-data section includes a distinguishing symbol for distinguishing the data section and the non-data section from each other, and such that a higher/lower relationship of a signal level of the distinguishing symbol with respect to the reference level is the same as the higher/lower relationship of a symbol immediately before the distinguishing symbol. In more detail, the mapping is performed such that: when the signal level of the symbol immediately before the distinguishing symbol is higher than the reference level, the signal level of the distinguishing symbol is higher than the reference level; and when the signal level of the symbol immediately before the distinguishing symbol is lower than the reference level, the signal level of the distinguishing symbol is lower than the reference level. Thus, an apparatus on the receiving side (26) can distinguish the data section and the non-data section from each other with certainty. The present invention is preferably applicable to sending and receiving of an S/PDIF frame, but the applicable scope of the present invention is not limited to the S/PDIF.

The distinguishing symbol may be mapped such that the signal level of the distinguishing symbol is equal to the signal level of the symbol immediately before the distinguishing symbol. Thus, the apparatus on the receiving side can detect the distinguishing symbol with certainty without paying attention to the reference level. Accordingly, this is especially effective to an environment, such as an in-vehicle environment, in which it is difficult to obtain a fixed reference level.

The distinguishing symbol may be any symbol included in a symbol stream forming the non-data section. It is preferable to provide the distinguishing symbol at the leading end of the non-data section because this allows the apparatus on the receiving side to distinguish the leading end of the non-data section as quickly as possible.

A data sending device (10) according to the present invention is for mapping each symbol of sending data to any one of a plurality of signal levels (+1.5, +0.5, −0.5, −1,5) and sending the sending data, and comprises a data mapping section (18) for mapping the sending data such that a higher/lower relationship (upper level or lower level) of a signal level of each symbol with respect to a reference level (0) is constantly inverted on a symbol by symbol basis; and a non-data mapping section (16) for mapping a non-data section (header section) to be transmitted in a state of being distinguished from a data section such that the non-data section includes a distinguishing symbol for distinguishing the data section and the non-data section from each other, and such that a higher/lower relationship of a signal level of the distinguishing symbol with respect to the reference level is the same as the higher/lower relationship of a symbol immediately before the distinguishing symbol.

A data receiving device (26) according to the present invention is for receiving a transmission signal which is sent in the state where each symbol of sending data is mapped to any one of a plurality of signal levels (+1.5, +0.5, −0.5, −1.5), and comprises a distinguishing symbol detection section (30) for detecting a distinguishing symbol for distinguishing a data section and a non-data section (header section) of the transmission signal from each other based on a change pattern of signal levels of the transmission signal; a data determination section (34) for reproducing data from the data section of the transmission signal based on a detection result of the distinguishing symbol detection section; and a non-data determination section (32) for reproducing non-data information (header information) from the non-data section of the transmission signal based on the detection result of the distinguishing symbol detection section.

### BRIEF DESCRIPTION OF THE DRAWINGS

FIG. 1 is a block diagram showing a structure of a data sending device according to Embodiment 1 of the present invention.

FIG. 2 is a diagram showing an output from a header mapping section 16 and an output from a data mapping section 18.

FIG. 3 is a diagram illustrating an operation of the data mapping section 18.

FIG. 4 shows a mapping table referred to by the data mapping section 18.

FIG. 5 is a diagram illustrating an operation of the header mapping section 16.

FIG. 6 is a diagram illustrating the operation of the header mapping section 16.

FIG. 7 is a block diagram showing a structure of a data receiving device according to Embodiment 1 of the present invention.

FIG. 8 is a diagram showing the relationship between a receiving signal and an output from a difference calculation section 36.

FIG. 9 shows an operation of a data determination section 34.

FIG. 10 shows an operation of a header determination section 32.

FIG. 11 is a diagram showing a part of structure of a data sending device according to Embodiment 2 of the present invention.

FIG. 12 is a diagram illustrating an operation of the data sending device according to Embodiment 2.

FIG. 13 is a diagram showing a part of structure of a data receiving device according to Embodiment 2 of the present invention.

FIG. 14 is a diagram showing an exemplary structure of a system according to a modification of the present invention.

FIG. 15 is a diagram showing a structure of transmission data in the modification.

FIG. 16 is a diagram showing a pattern of a signal waveform of a data section in the modification.

FIG. 17 is a diagram showing a pattern of a signal waveform of a non-data section in the modification.

FIG. 18 is a diagram illustrating biphase mark encoding.

FIG. 19 is a diagram illustrating a structure of an S/PDIF frame.

FIG. 20 shows a header section of an S/PDIF frame.

FIG. 21 is a diagram showing a structure of a conventional sending and receiving device for sending and receiving an S/PDIF frame via an optical fiber.

FIG. 22 is a diagram showing a structure of a conventional sending and receiving device for sending and receiving an S/PDIF frame via a conductor.

FIG. 23 is a diagram showing a mapping example for mapping 2-bit data to a predetermined signal level as one symbol.

FIG. 24 is a diagram showing a mapping example for mapping 1-bit data to a predetermined signal level as one symbol.

### BEST MODE FOR CARRYING OUT THE INVENTION

Hereinafter, various embodiments of the present invention will be described with reference to the drawings.

(Embodiment 1)

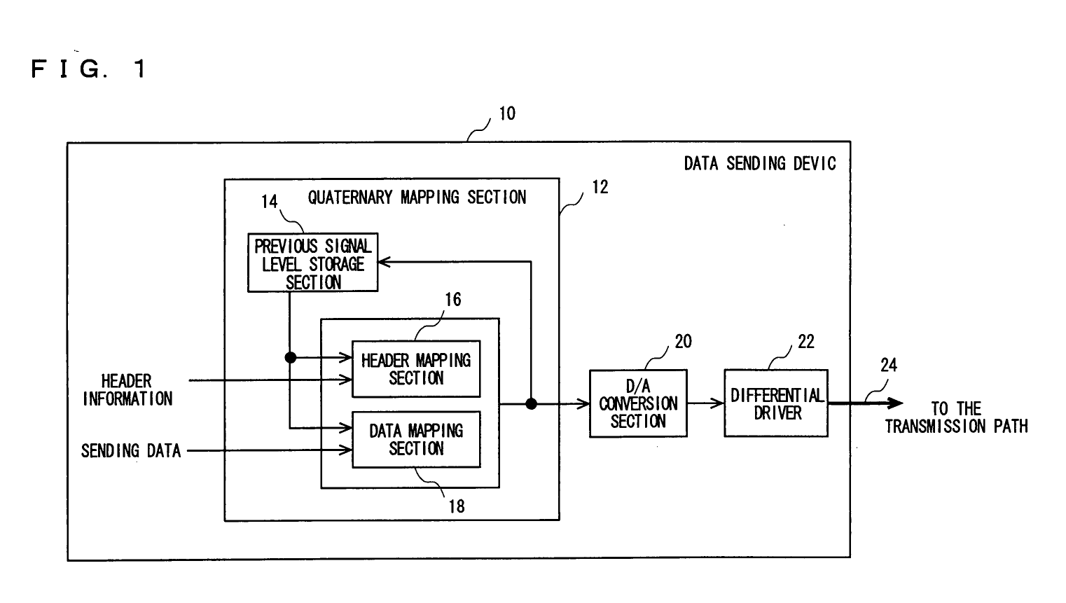

First, a data sending device and a data receiving device according to Embodiment 1 of the present invention will be described. FIG. 1 shows a structure of the data sending device. In FIG. 1, a data sending device 10 includes a quaternary mapping section 12 for performing quaternary mapping on sending data, a D/A conversion section 20 for converting a digital signal which is output from the quaternary mapping section 12 into an analog signal, and a differential driver 22 for sending symmetrical signals to two cables of a twisted pair cable 24 based on the post-D/A conversion signal. Although not shown, a digital filter such as a roll-off filter or the like is provided on a stage after the quaternary mapping section 128, and an analog filter is adequately provided on, for example, a stage after the D/A conversion section 20.

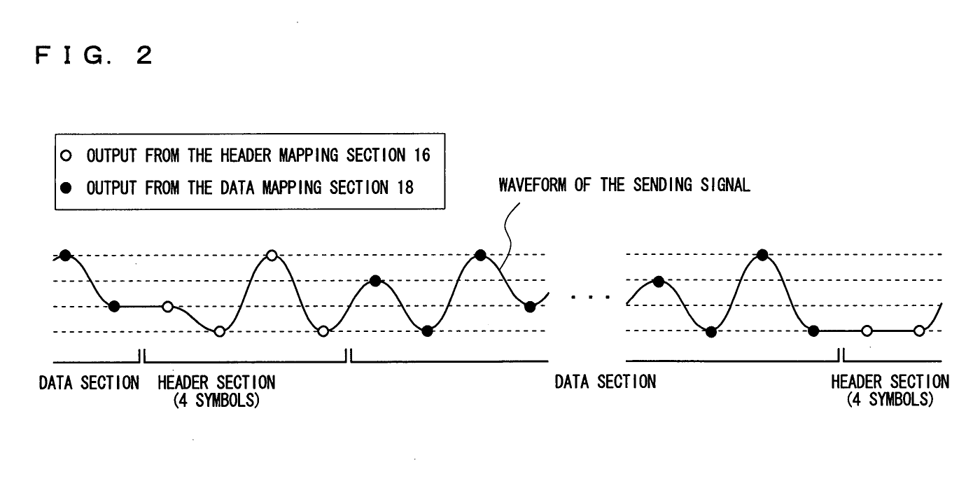

The quaternary mapping section 12 includes a previous signal level storage section 14, a header mapping section 16, and a data mapping section 18. The header mapping section 16 adds, to the sending data, a header section mapped to a predetermined signal level based on header information which is generated by the data sending device 10 (or which is input from an apparatus connected to the data sending device 10). The header mapping section 16 may be adapted to periodically add a header without providing the header information to the header mapping section 16. The data mapping section 18 maps each symbol of the sending data (here, 1-bit data) which is generated by the data sending device 10 (or which is input from an apparatus connected to the data sending device 10) to a predetermined signal level, and thus generates a data section of the sending data. As a result of processing performed by the header mapping section 16 and the data mapping section 18, a symbol stream as shown in FIG. 2 is generated and output to the D/A conversion section 20. The previous signal level storage section 14 sequentially stores the signal level of a symbol which is output immediately previously from the quaternary mapping section 12, and supplies the value thereof to the header mapping section 16 and the data mapping section 18. Hereinafter, the processing of the quaternary mapping section 12 will be described, separately regarding the processing on a data section and the processing on a header section.

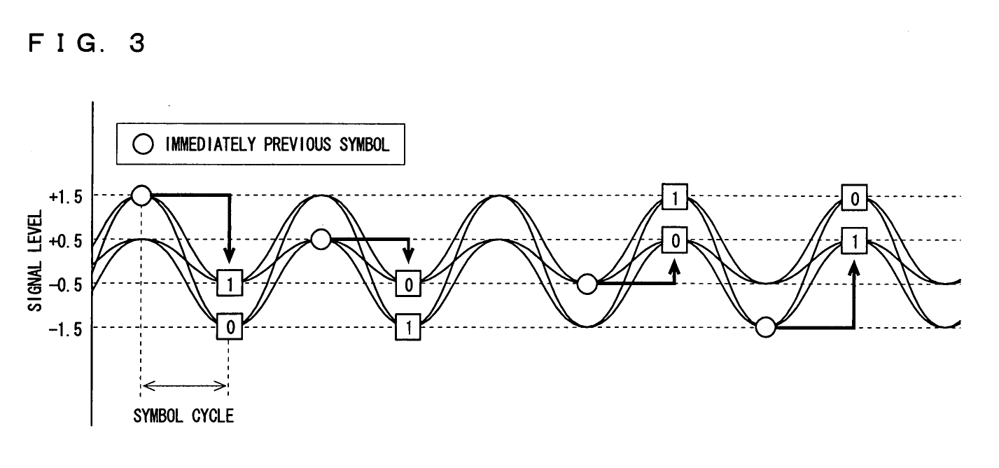

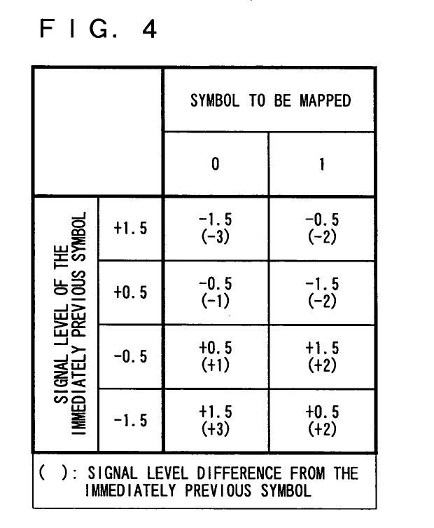

First, with reference to FIG. 3 and FIG. 4, an operation of the data mapping section 18 will be described.

The data mapping section 18 sequentially maps each symbol of the sending data (here, 1-bit data) to any one of four signal levels (+1.5, +0.5, −0.5, −1.5) as shown in FIG. 3. The values of these signal levels are merely exemplary. The four signal levels are classified into an upper level (+1.5, +0.5) and a lower level (−0.5, −1.5) with a reference level (here, level 0) as the border. Each symbol of the sending data is mapped alternately to the upper level and the lower level. This mapping is performed in accordance with a mapping table held by the data mapping section 18. FIG. 4 shows a specific example of the mapping table. The data mapping section 18 refers to the mapping table and determines the signal level based on the sign of the symbol to be mapped and the value supplied from the previous signal level storage section 14 (i.e., the signal level of the symbol immediately before the symbol to be mapped). For example, when the sign of the symbol to be mapped is 1 and the signal level to which the symbol immediately there before is mapped is +1.5, the symbol to be mapped is mapped to the signal level of −0.5.

In the mapping table shown in FIG. 4, the numerals in the parentheses each show a difference from the signal level of the immediately previous symbol. In the data receiving device described later, pre-mapping sending data is reproduced based on the difference. In more detail, when the difference from the signal level of the immediately previous symbol is any one of −3, −1, +1, and +3, the sending data can be determined as being 0. When the difference from the signal level of the immediately previous symbol is either −2 or +2, the sending data can be determined as being 1. By transmitting data in relation with the signal level difference between two consecutive symbols, the signal level acting as a reference (for example, the ground level) is not required when reproducing the data. This is especially effective when the signal level acting as a reference is different between the data sending device and the data receiving device. The present invention is not limited to this, and, for example, symbol 0 may be mapped to the signal level of +0.5 or −0.5 whereas symbol 1 may be mapped to the signal level of +1.5 or −1.5, regardless of the signal level of the immediately previous symbol.

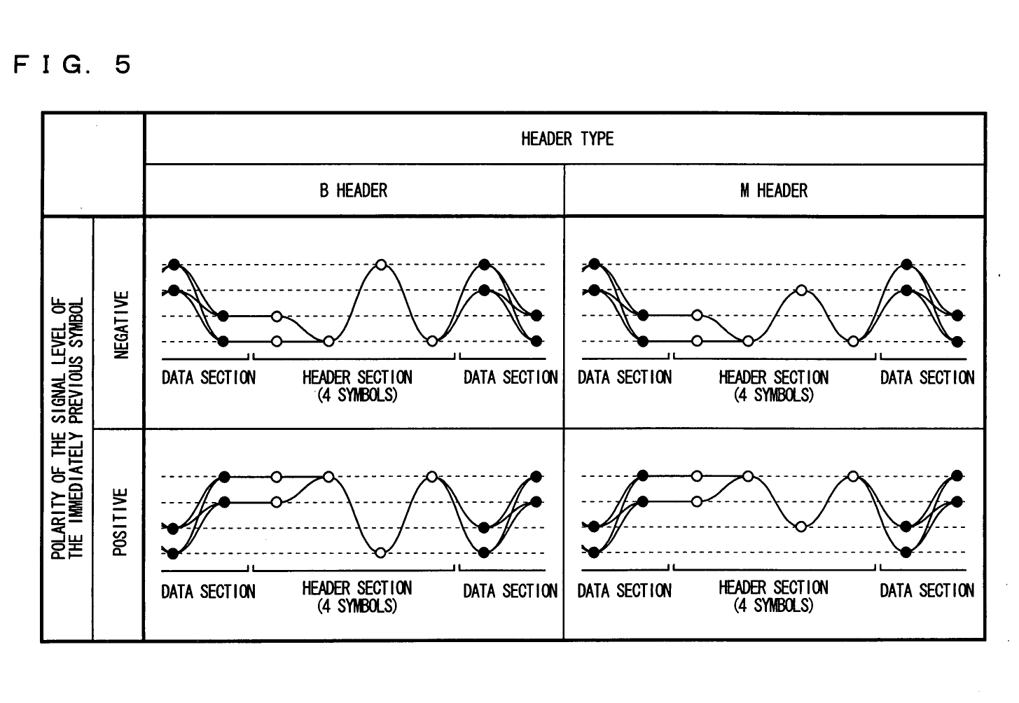

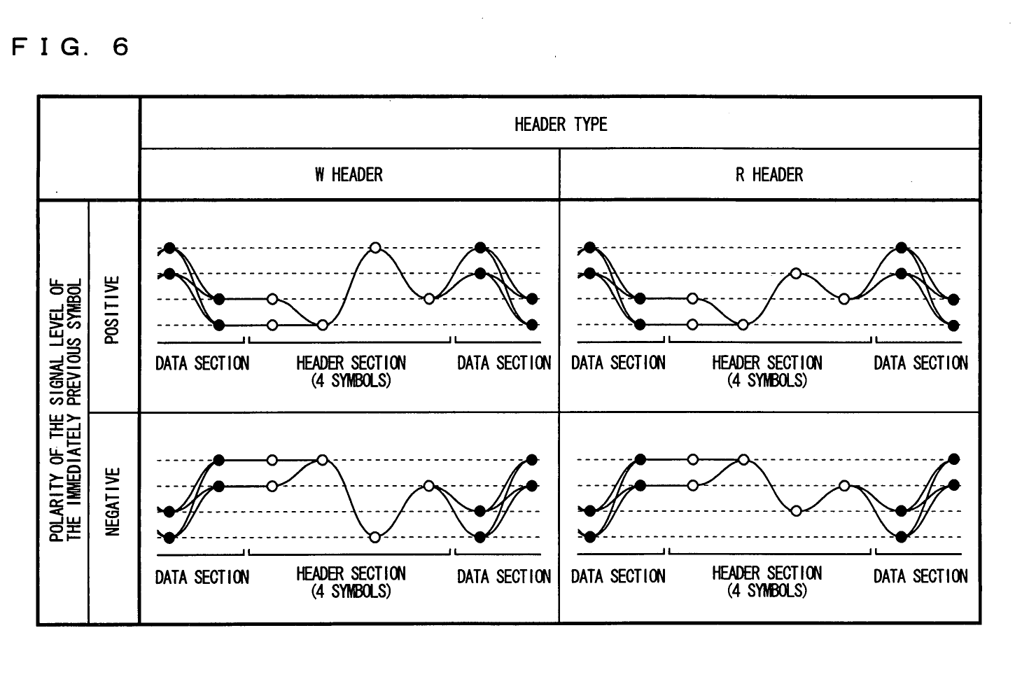

Next, with reference to FIG. 5 and FIG. 6, an operation of the header mapping section 16 will be described.

As shown in FIG. 2, a header section includes 4 symbols. The header mapping section 16 prepares a plurality of output patterns in advance for each header type, and outputs a header pattern corresponding to the header type to be added. FIG. 5 and FIG. 6 show header patterns prepared in the header mapping section 16. FIG. 5 and FIG. 6 show outputs of the header mapping section 16 corresponding to four types of headers of a B header, an M header, a W header and an R header. Which header of these four types of headers is to be selected is determined based on the header information which is input to the header mapping section 16. In addition, the header mapping section 16 generates four patterns of outputs in accordance with the value supplied from the previous signal level storage section 14 (i.e., the signal level of the last symbol of the data section) for each header type. For example, when the header type is the B header and the value supplied from the previous signal level storage section 14 is −0.5, from FIG. 5, the header mapping section 16 sequentially outputs four symbols respectively having signal levels of −0.5, −1.5, +1.5 and −1.5. For example, when the header type is the W header and the value supplied from the previous signal level storage section 14 is −1.5, from FIG. 6, the header mapping section 16 sequentially outputs four symbols respectively having signal levels of −1.5, −1.5, +1.5 and −0.5.

All the headers are common in that the leading symbol of the header is mapped to the signal level equal to the signal level of the immediately previous symbol (i.e., the last symbol of the data section). As described above, the symbols of the data section are mapped such that the polarity of the signal level is constantly inverted on a symbol by symbol basis. Therefore, the data receiving device described later can distinguish the header section and the data section from each other with certainty by detecting a symbol which is mapped to the signal level equal to the signal level of the immediately previous symbol. Thus, the leading symbol of the header section is a special symbol for distinguishing the header section and the data section from each other, and this symbol will be referred to as a distinguishing symbol hereinafter. A distinguishing symbol is not necessarily a leading symbol of the header section, but it is preferable that the leading symbol of the header section is the distinguishing symbol in order to distinguish the header section as quickly as possible by the data receiving device.

In this embodiment, the signal level of a distinguishing symbol is equal to the signal level of the immediately previous symbol. The present invention is not limited to this, and the signal level of a distinguishing symbol may be arbitrarily set as long as at least the data section and the header section can be distinguished from each other. For example, when the signal level of the distinguishing symbol is set such that the polarity of the signal level of the distinguishing symbol (i.e., a higher/lower relationship of the signal level of the distinguishing symbol with respect to a reference level, namely, whether the signal level of the distinguishing symbol is higher or lower than the reference level) is the same as the polarity of the symbol immediately before the distinguishing symbol, the distinguishing symbol can be detected by monitoring a change in the polarity by the data receiving device. In order to monitor the change in the polarity, however, it is necessary that the reference level is established. Therefore, in a situation where the establishment of the reference level is difficult, it is desirable that the distinguishing symbol can be detected even if the reference level is not established. For example, the signal level of the distinguishing symbol can be set to be equal to or higher than the signal level of the symbol immediately before the distinguishing symbol when the signal level of the symbol immediately before the distinguishing symbol is higher than the reference level, and the signal level of the distinguishing symbol can be set to be equal to or lower than the signal level of the symbol immediately before the distinguishing symbol when the signal level of the symbol immediately before the distinguishing symbol is lower than the reference level. In this case, the data receiving device can detect the distinguishing symbol merely by monitoring an increase/decrease pattern of the signal level. Moreover, as shown in FIG. 6, the signal level of the distinguishing symbol can be set to be equal to the signal level of the symbol immediately before the distinguishing symbol. In this case, the data receiving device can detect the distinguishing symbol merely by monitoring whether the signal level has changed or not. Thus, the distinguishing symbol can be easily detected.

The header section has three symbols in addition to the distinguishing symbol. The header type can be distinguished by the pattern of the signal levels of these three symbols. In the example shown in FIG. 5 and FIG. 6, the second symbol of the header section is set to have the same polarity as that of the distinguishing symbol and to have the maximum amplitude level for all the types of headers. The header type is indicated by the pattern of the signal levels of the third and fourth symbols (i.e., 2-bit information). This is merely an example, and the pattern of the header section except for the distinguishing symbol can be arbitrarily set. As described later, though, the data receiving device recovers a clock signal by extracting a frequency component, which is half of the frequency of the symbol, from the receiving signal using a bandpass filter and inputting the extraction result to a PLL. Therefore, in order to obtain a stable extraction result from the bandpass filter, the signal level of each symbol of the header section (especially, the signal level of the last symbol of the header section) should be appropriately set such that the change pattern of the signal levels of the data section (the pattern of upper level→lower level→upper level→lower level) does not change. For example, in the case where a header section includes even numbered symbols, it is preferable that the polarity of the signal level of the last symbol of the header section is matched to the polarity of the signal level of the last symbol of the data section which is immediately before the header section.

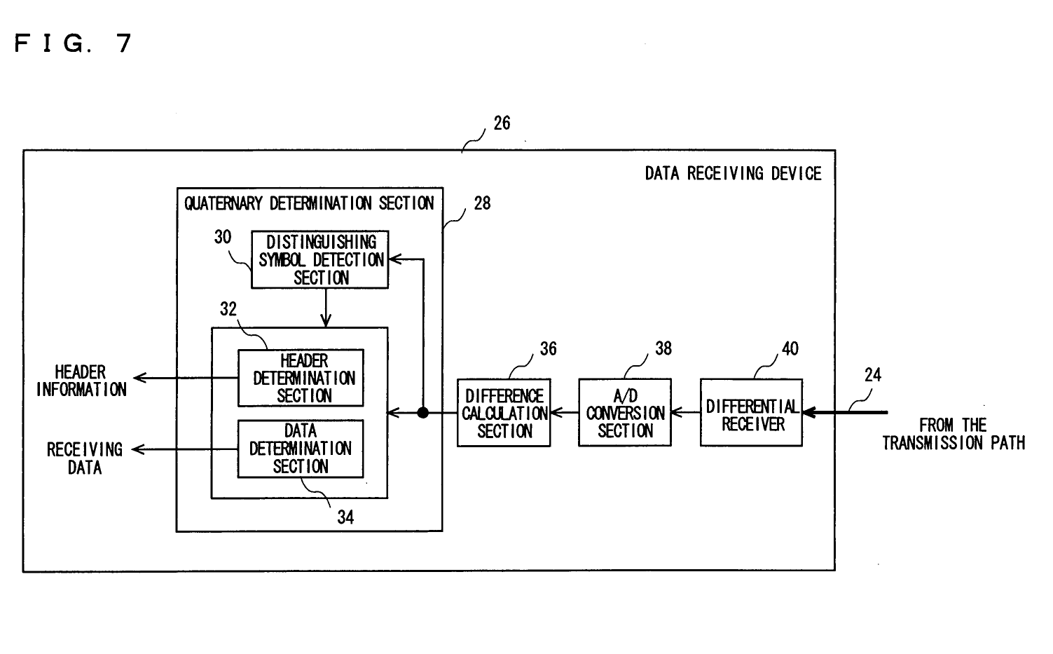

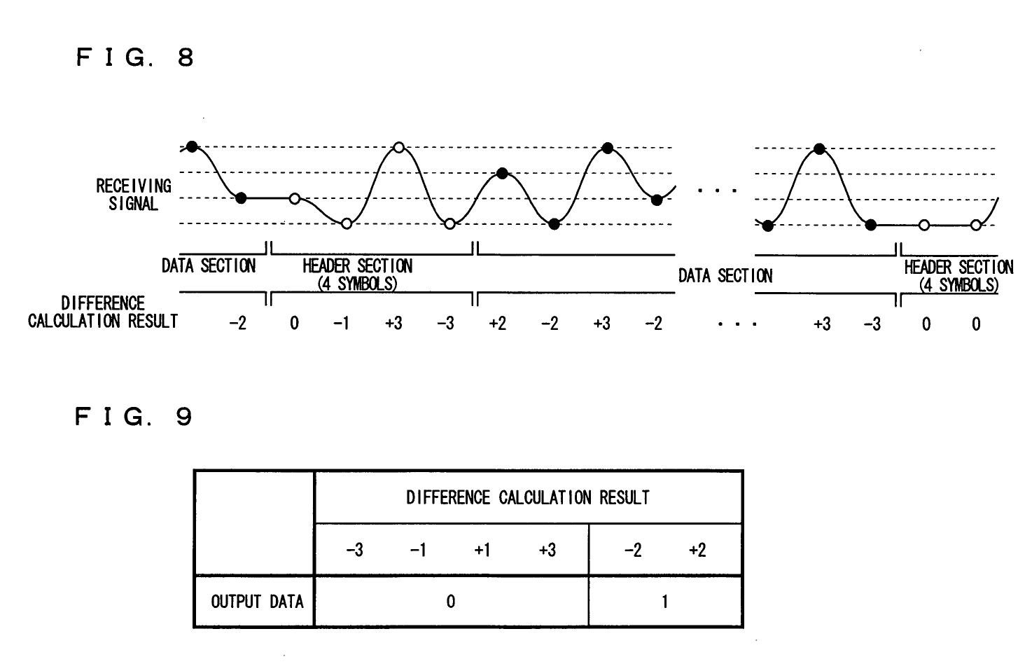

FIG. 7 shows a structure of the data receiving device. In FIG. 7, a differential receiver 40 receives an input transmission Signal which is sent from the data sending device 10 shown in FIG. 1 via the twisted pair cable 24. The differential receiver 40 outputs a difference between the signals transmitted by the two cables of the twisted pair cable 24, and this output is converted into a digital signal by an A/D conversion section 38. The output data from the A/D conversion section 38 is input to a difference calculation section 36. The difference calculation section 36 sequentially calculates and outputs a signal level difference between each symbol and a symbol immediately before the each symbol on a symbol by symbol basis. FIG. 8 shows the relationship between a receiving signal and the calculation result of the difference calculation section 36. The calculation result of the difference calculation section 36 is input to a quaternary determination section 28.

The quaternary determination section 28 includes a distinguishing symbol detection section 30 for detecting a distinguishing symbol from the receiving signal, a header determination section 32 for reproducing header information from the header section of the receiving signal, and a data determination section 34 for reproducing receiving data (corresponding to the sending data in FIG. 1) from the data section also of the receiving signal. As is clear from FIG. 8, the difference calculation result corresponding to the distinguishing symbol is 0. The distinguishing symbol detection section 30 monitors outputs from the difference calculation section 36. When 0 is output as a difference calculation result corresponding to a symbol, the distinguishing symbol detection section 30 detects this symbol as a distinguishing symbol. The header determination section 32 and the data determination section 34 distinguish the header section and the data section based on the detection result of the distinguishing symbol detection section 30, and respectively process the header section and the data section. Hereinafter, an operation of the header determination section 32 and an operation of the data determination section 34 will be described.

First, with reference to FIG. 9, an operation of the data determination section 34 will be described.

The data determination section 34 refers to a conversion table shown in FIG. 9 to sequentially convert the difference calculation result to the sign of 0 or 1 and outputs the resultant sign. In more detail, when the difference calculation result is any one of −3, −1, +1 and +3, the data determination section 34 outputs 0; and when the difference calculation result is either −2 or +2, the data determination section 34 outputs 1. The receiving data is reproduced by the data determination section 34 in this manner.

Next, with reference to FIG. 10, an operation of the header determination section 32 will be described.

The header determination section 32 distinguishes the header type based on the difference calculation results corresponding to four symbols starting from the distinguishing symbol (i.e., the header section) obtained based on the detection result of the distinguishing symbol detection section 30. In this embodiment, four header types (the B header, M header, W header and R header) can be distinguished by referring to the difference calculation results respectively corresponding to the third symbol and the fourth symbol of the header section. Specifically, when the difference calculation result corresponding to the third symbol of the header is −2 and the difference calculation result corresponding to the fourth symbol of the header section is +2, this header can be distinguished as the M header based on the determination table shown in FIG. 10. The header determination section 32 outputs the header type thus distinguished as header information.

In this embodiment, the distinguishing symbol detection section 30 monitors the outputs from the difference calculation section 36 and, when 0 is output as a difference calculation result of a symbol, detects this symbol as the distinguishing symbol. Needless to say, however, in the case where, for example, the mapping method of the distinguishing symbol in the data sending device 10 is different from that in this embodiment, the operation of the distinguishing symbol detection section 30 needs to be optimized accordingly. For example, in the case where the signal level of the distinguishing symbol is set such that the polarity of the signal level of the distinguishing symbol (the higher/lower relationship of the signal level of the distinguishing symbol with respect to the reference level) is the same as the polarity of the symbol immediately before the distinguishing symbol, the distinguishing symbol detection section 30 can detect the distinguishing symbol by monitoring a change in the polarity of the receiving signal, not by monitoring the difference calculation result of the difference calculation section 36. Alternatively, for example, in the case where the signal level of the distinguishing symbol is set to be equal to or higher than the signal level of the symbol immediately before the distinguishing symbol when the signal level of the symbol immediately before the distinguishing symbol is higher than the reference level, and the signal level of the distinguishing symbol is set to be equal to or lower than the signal level of the symbol immediately before the distinguishing symbol when the signal level of the symbol immediately before the distinguishing symbol is lower than the reference level, the distinguishing symbol detection section can detect the distinguishing symbol by monitoring a change in the sign of the difference calculation result.

As described above, according to the data sending device and the data receiving device of this embodiment, the data section and the header section can be distinguished from each other with certainty by the data receiving device based on a distinguishing symbol. In this embodiment, the data section and the header section are transmitted in the state of being distinguished from each other. The present invention is not limited to transmission of a header section, but is widely applicable to the case where arbitrary information which is to be transmitted in a state of being distinguished from data is transmitted as a non-data section.

(Embodiment 2)

Next, a data sending device and a data receiving device according to Embodiment 2 of the present invention will be described. The data sending device and the data receiving device send or receive an S/PDIF frame as shown in FIG. 19.

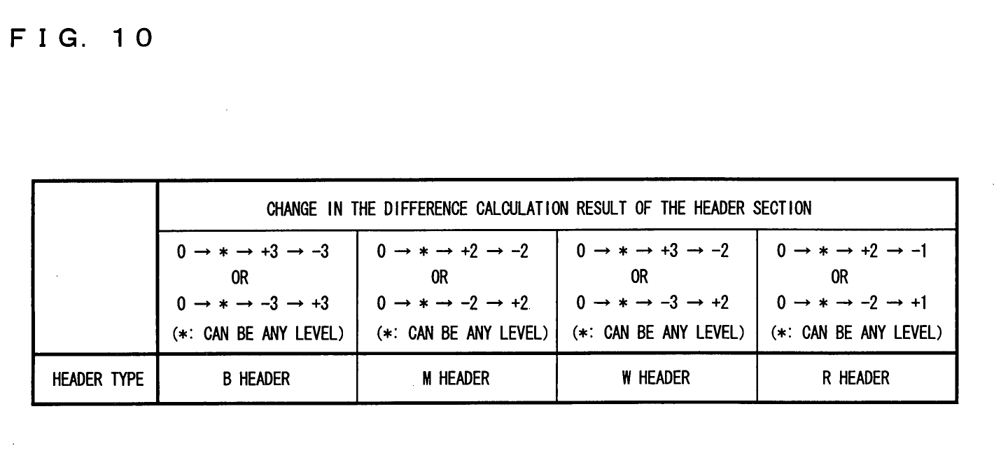

First, a data sending device according to Embodiment 2 will be described. FIG. 11 shows a part of a structure of the data sending device. The data sending device according to Embodiment 2 is different from the data sending device according to Embodiment 1 shown in FIG. 1 only in that the former includes a header distinguishing section 42 and a biphase decoder 44 on a stage before the quaternary mapping section 12. The other parts of the structure of the data sending device according to Embodiment 2 is identical to that of the data sending device according to Embodiment 1, and descriptions thereof will be omitted.

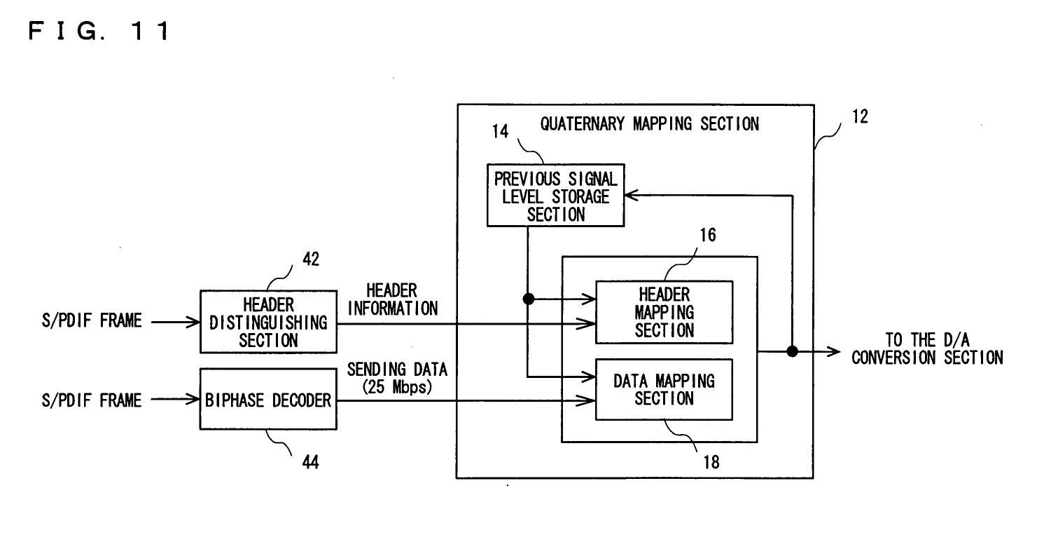

The header distinguishing section 42 and the biphase decoder 44 respectively receive an input header section and an input data section of an S/PDIF frame to be sent to the data receiving device. The header distinguishing section 42 distinguishes the header type based on the pattern of the header section of the S/PDIF frame, and supplies the distinguishing result to the header mapping section 16 as header information. On the other hand, the biphase decoder 44 biphase-mark-decodes the data section of the S/PDIF frame and supplies the decoding result to the data mapping section 18. The output data from the biphase decoder 44 corresponds to original data, i.e., the data before the biphase mark encoding performed by the S/PDIF controller. The processing performed by the quaternary mapping section 12 and the elements thereafter is the same as that in Embodiment 1. The signal which is sent out from the data sending device as a result of such processing has a waveform as shown in FIG. 12. In the structure shown in FIG. 11, the header distinguishing section 42 and the biphase decoder 44 are independently provided from the quaternary mapping section 12. The present invention is not limited to this, and, for example, the header mapping section 16 and the data mapping section 18 may be respectively structured to have the functions of the header distinguishing section 42 and the biphase decoder 44.

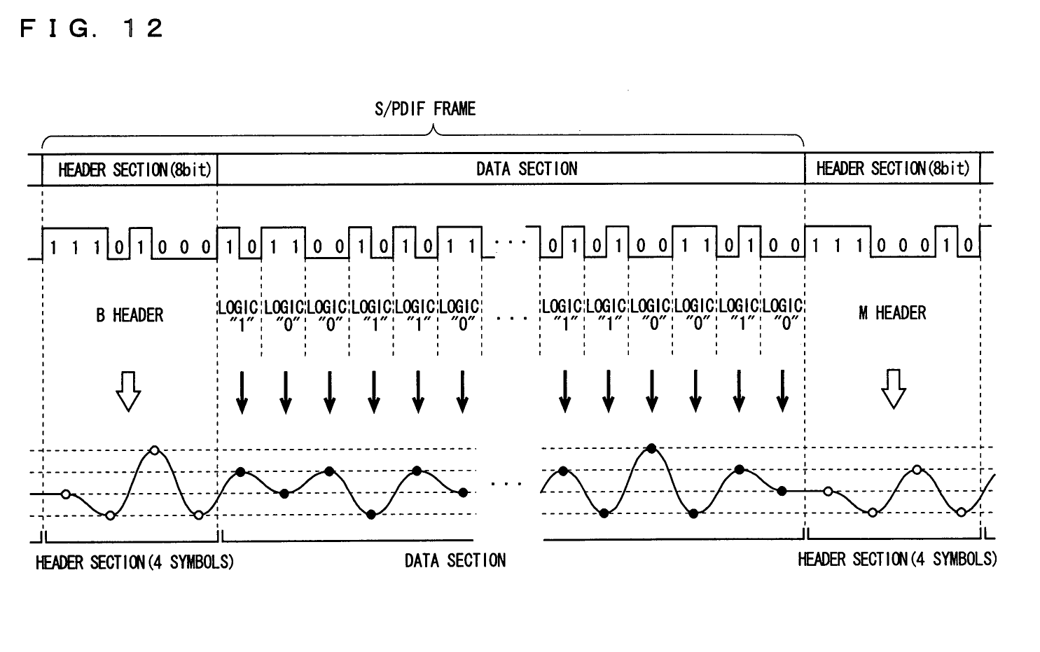

Next, the data receiving device according to Embodiment 2 will be described. FIG. 13 shows a part of a structure of the data receiving device. The data receiving device according to Embodiment 2 is different from the data receiving device according to Embodiment 1 shown in FIG. 7 only in that the former includes a header generation section 46 and a biphase encoder 48 on a stage after the quaternary determination section 28. The other parts of the structure of the data receiving device according to Embodiment 2 is identical to that of the data receiving device according to Embodiment 1, and descriptions thereof will be omitted.

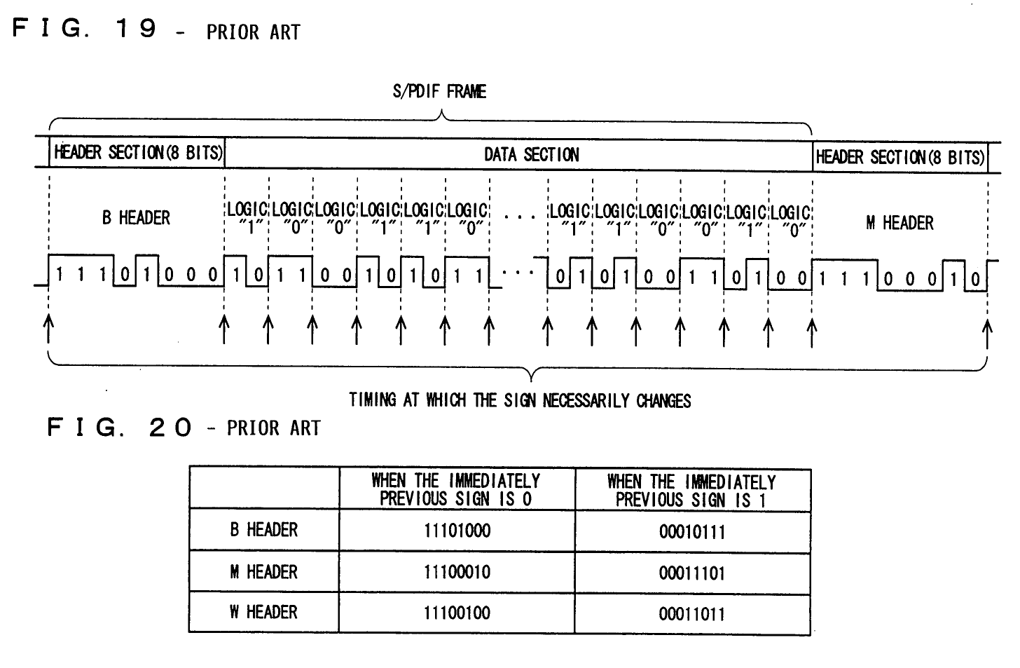

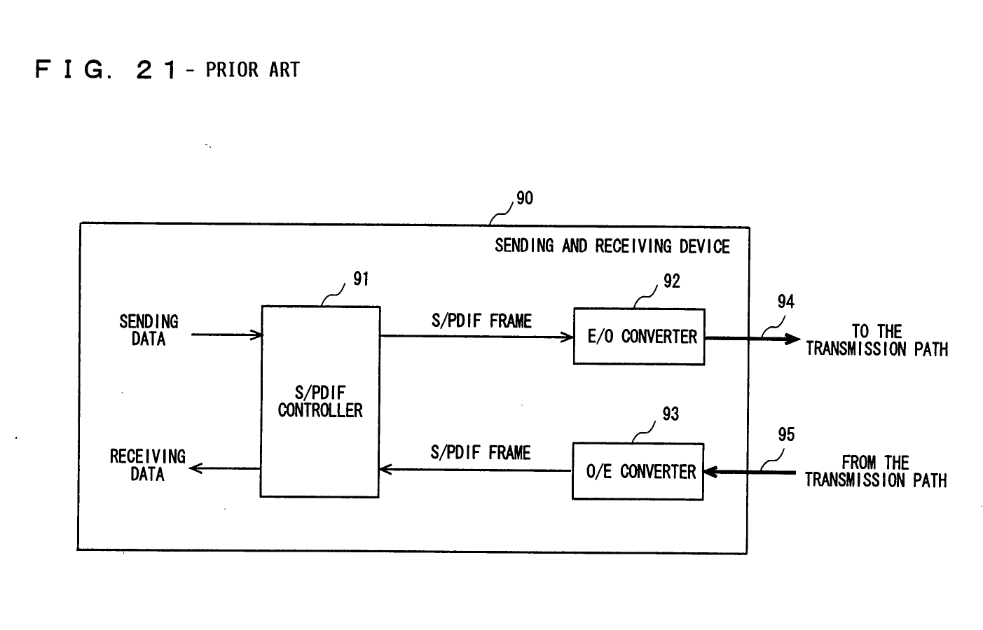

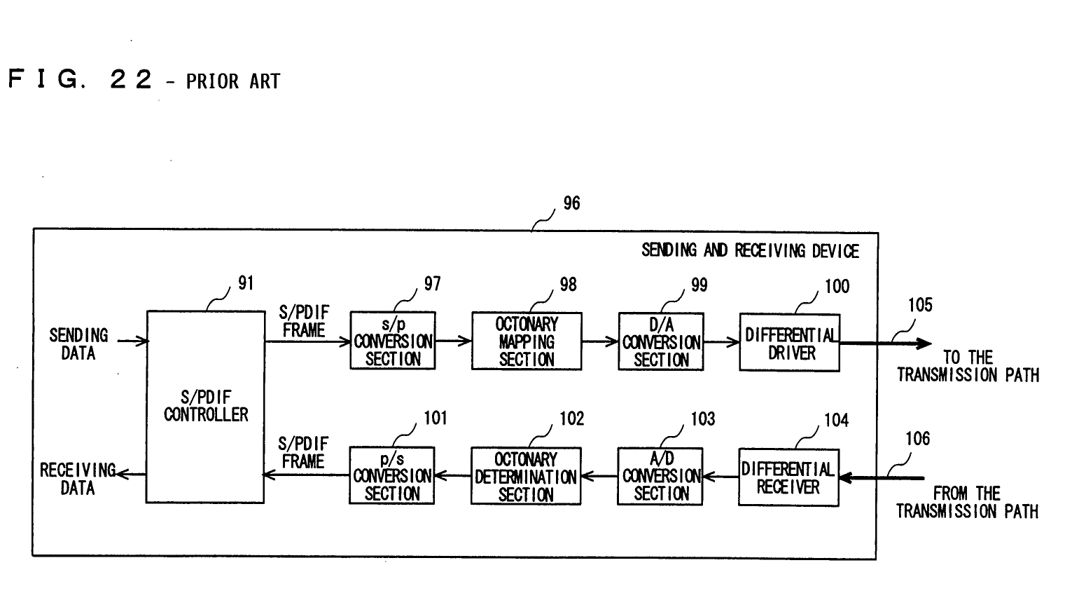

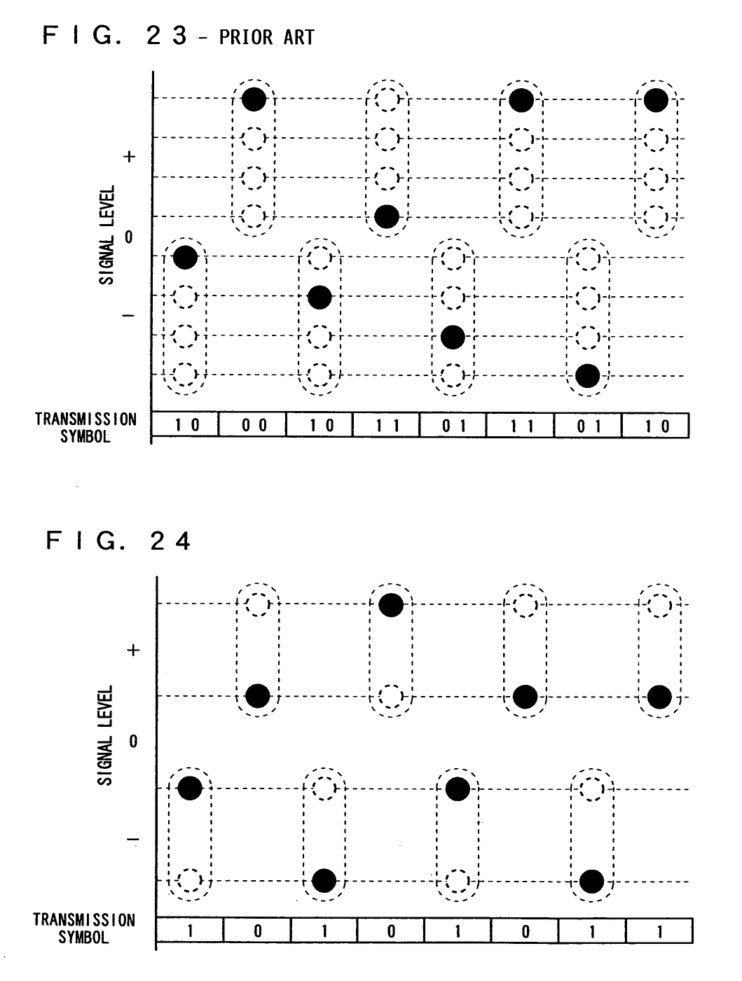

The quaternary determination section 28 outputs header information and sending data reproduced based on the transmission signal sent from the data sending device. The header information and the sending data are respectively input to the header generation section 46 and the biphase encoder 48. The header generation section 46 generates a header section of an S/PDIF frame as shown in FIG. 20 based on the header information from the header determination section 32 and outputs the header section. On the other hand, the biphase encoding section 48 biphase-mark-encodes the sending data which is output from the data determination section 34, and outputs the encoding result as a data section of the S/PDIF frame. In this manner, the S/PDIF frame transmitted by the data sending device is reproduced by the header generation section 46 and the biphase encoder 48. In the structure shown in FIG. 13, the header generation section 46 and the biphase encoder 48 are independently provided from the quaternary determination section 28. The present invention is not limited to this, and, for example, the header determination section 32 and the data determination section 34 may be respectively structured to have the functions of the header generation section 46 and the biphase encoder 48.

As described above, according to Embodiment 2, for transmitting an S/PDIF frame via a conductor such as a twisted pair cable or the like, 2-bit data of the S/PDIF frame is quaternary-mapped as one symbol. Therefore, radiation noise can be suppressed. Moreover, an 8-bit header section of the S/PDIF frame can be transmitted by four symbols, and also the apparatus on the receiving side can distinguish the header section and the data section from each other with certainty. Since the S/PDIF frame which is output from the S/PDIF controller on the sending side can be input as it is with no change in the format to the S/PDIF controller on the receiving side, the S/PDIF system can be optimized to data transfer using a conductor without changing the structure of the existing S/PDIF controller.

In Embodiments 1 and 2 described above, the data sending device and the data receiving device respectively have only the data sending function and only the data receiving function. Alternatively, these devices may be structured as a data sending and receiving device having both the data sending function and the data receiving function.

(Modification)

In Embodiments 1 and 2 described above, the data section and the header section are transmitted in the state of being distinguished from each other. The present invention is not limited to transmission of a header section, but is widely applicable to the case where arbitrary information which is to be transmitted in a state of being distinguished from data is transmitted as a non-data section.

A conceivable example of information which is to be transmitted in a state of being distinguished from data is a data identifier indicating the type of data included in a data section (for example, an identifier indicating whether data included in the data section is audio data or video data). Another conceivable example of information which is to be transmitted in a state of being distinguished from data is control data (for example, time information on video data included in the data section or data designating the frame number or scanning line number).

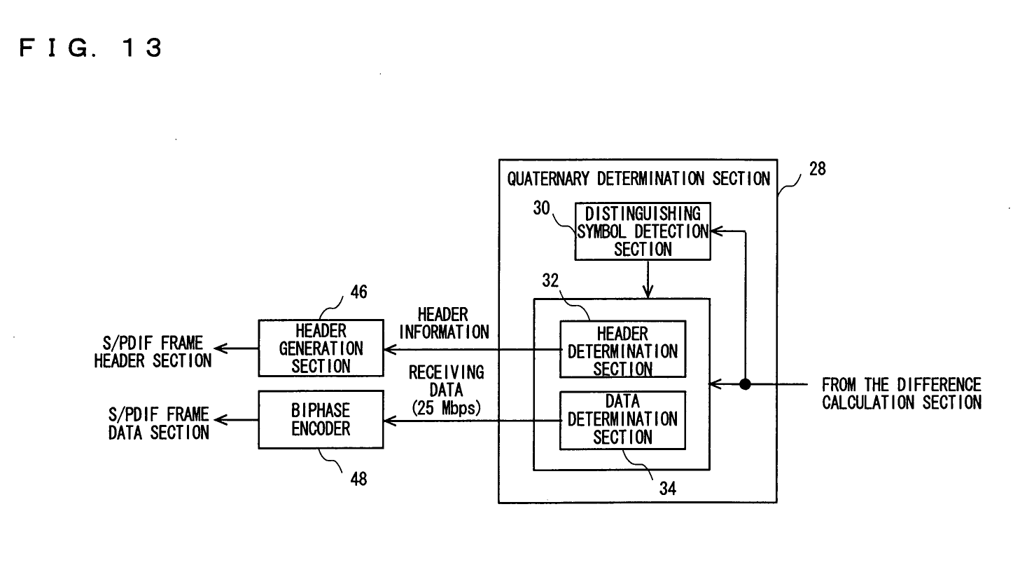

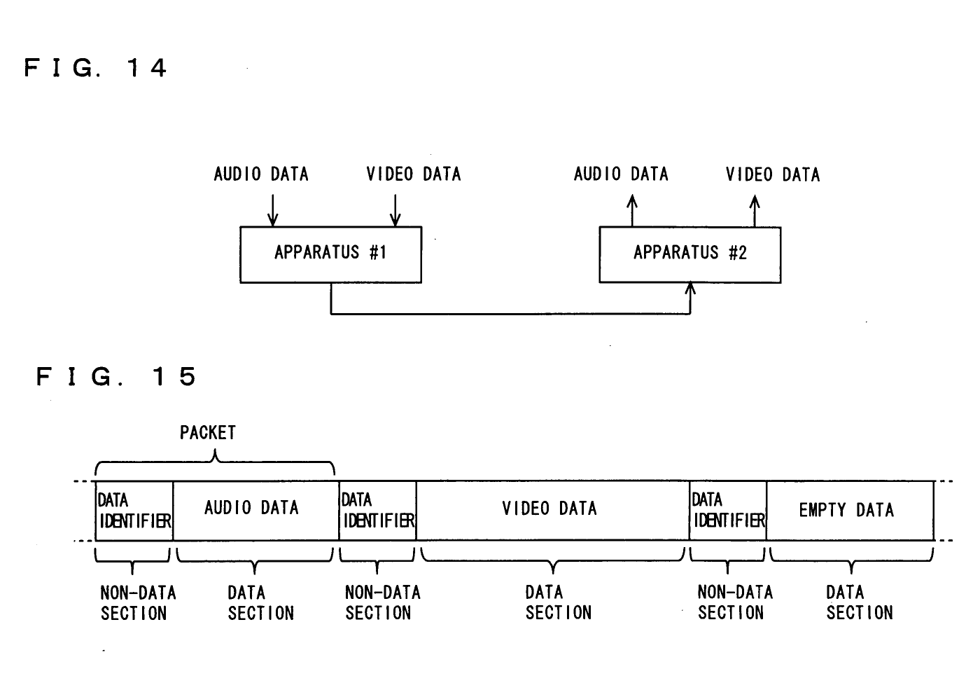

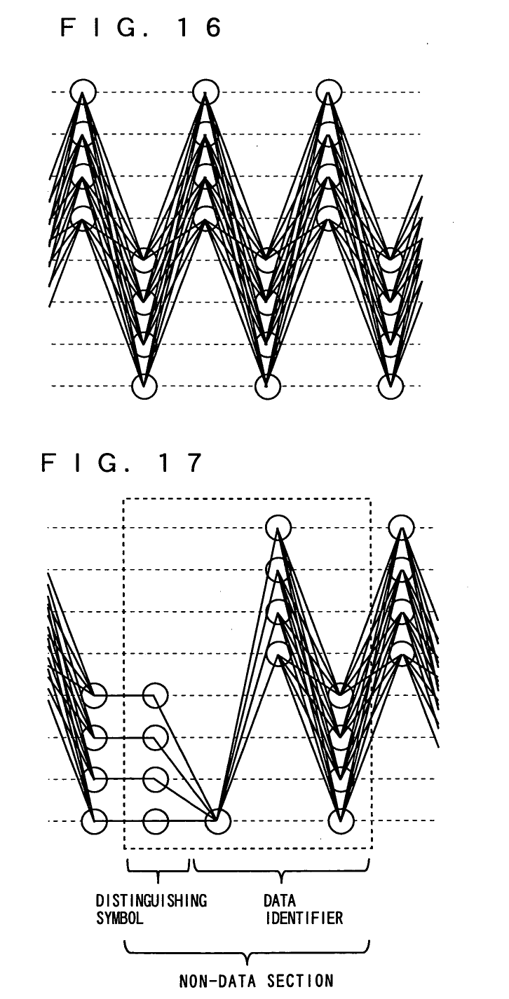

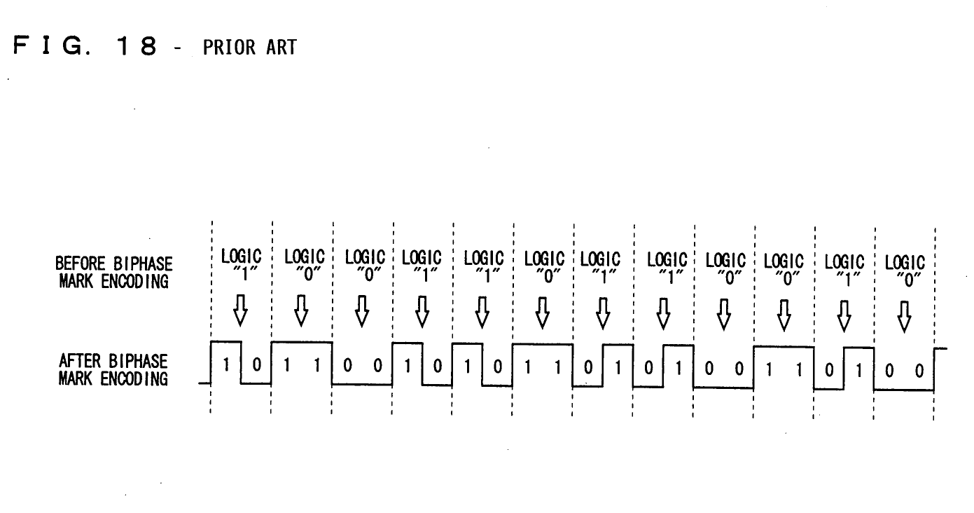

FIG. 14 shows an exemplary structure of a system for transmitting a data identifier in a non-data section. In this system, audio data and video data are transmitted from apparatus #1 to apparatus #2. FIG. 15 shows a structure of transmission data in this system. The transmission data is transmitted on a packet by packet basis. Each packet includes a non-data section and a data section. Apparatus #1 adds a non-data section which is different in accordance with the data to be transmitted. On the other hand, apparatus #2 outputs the audio data and the video data in the state of being separated from each other based on the received non-data section. The non-data section includes a data identifier indicating the type of data of the corresponding data section. Since the start timing of each packet is distinguishable on the receiving side by detecting a distinguishing symbol included in the non-data section, the length of the data section included in each packet can be arbitrarily determined on the sending side. FIG. 16 shows a signal pattern of the data section. In Embodiments 1 and 2, each bit of the sending data is mapped to a predetermined signal level as one symbol using quaternary mapping. FIG. 16 shows a signal waveform pattern in the case where each 2 bits of the data section are mapped to a predetermined signal level as one symbol using octonary mapping. FIG. 17 shows a signal pattern of the non-data section. In the example of FIG. 17, one symbol can be at any one of four signal levels in the latter half of the non-data section. Accordingly, 16 types of information (i.e., 4-bit information) can be transmitted as the data identifier.

Transmission of control data in the non-data section can be performed in substantially the same manner.

In the case where octonary mapping is used as in this example, frame data including a header section and a biphase-mark-encoded data section can be transmitted at twice the speed as the speed in the case of quaternary mapping.

In the example of FIG. 17, the non-data section includes four symbols. The number of symbols in the non-data section is arbitrary. By increasing the number of symbols in the non-data section, a greater amount of information can be transmitted as a data identifier or control data.

### INDUSTRIAL APPLICABILITY

The present invention is preferable in, for example, a system for transferring data among a plurality of apparatuses in an in-vehicle LAN or the like, for transmitting a non-data section to be transmitted in a state of being distinguished from a data section, such as a header section of an S/PDIF frame, and the data section such that the non-data section and the data section can be distinguished from each other with certainty by the apparatus on the receiving side.

1. A data sending device for mapping each symbol of sending data to any one of a plurality of signal levels and sending the sending data, the data sending device comprising:
a data mapping section for mapping the sending data such that a higher/lower relationship of a signal level of each symbol with respect to a reference level is constantly inverted on a symbol by symbol basis; and
a non-data mapping section for mapping a non-data section transmitted in a state of being distinguished from a data section, such that the non-data section includes a distinguishing symbol for distinguishing the data section and the non-data section from each other, and such that a higher/lower relationship of a signal level of the distinguishing symbol with respect to the reference level is the same as the higher/lower relationship of a symbol immediately before the distinguishing symbol.

2. A data sending device according to claim 1, wherein the non-data mapping section performs the mapping such that:
a) when the signal level of the symbol immediately before the distinguishing symbol is higher than the reference level, the signal level of the distinguishing symbol is equal to or higher than the signal level of the symbol immediately before the distinguishing symbol; and
b) when the signal level of the symbol immediately before the distinguishing symbol is lower than the reference level, the signal level of the distinguishing symbol is equal to or lower than the signal level of the symbol immediately before the distinguishing symbol.

3. A data sending device according to claim 1, wherein the non-data mapping section performs the mapping such that the signal level of the distinguishing symbol is equal to the signal level of the symbol immediately before the distinguishing symbol.

4. A data sending device according to claim 1, wherein the non-data mapping section performs the mapping such that a leading symbol of the non-data section is the distinguishing symbol.

5. A data sending device according to claim 1, wherein the non-data section is header information added to the data section.

6. A data sending device according to claim 5, wherein the non-data mapping section outputs a symbol stream having a predetermined pattern for distinguishing a header type in addition to the distinguishing symbol.

7. A data sending device according to claim 6, wherein based on data indicating the header type, the non-data mapping section selects a symbol stream corresponding to the header type from a plurality of patterns of symbol streams prepared in advance.

8. A data sending device according to claim 1, wherein:
data to be transmitted is frame data including an 8-bit header section and a biphase-mark-encoded data section;
the non-data mapping section converts the header section of the frame data into a symbol stream including four symbols including the distinguishing symbol in accordance with a header type of the header section; and
the data mapping section biphase-mark-decodes the data section of the frame data, and maps each symbol such that the higher/lower relationship thereof with respect to a reference level is constantly inverted on a symbol by symbol basis, with each bit of the decoded data being one symbol.

9. A data sending device according to claim 1, further comprising a previous signal storage section for storing outputs from the data mapping section and the non-data mapping section, and supplying the outputs to the data mapping section and the non-data mapping section.

10. A data receiving device for receiving a transmission signal which is sent in the state where each symbol of sending data is mapped to any one of a plurality of signal levels, the data receiving device comprising:
a distinguishing symbol detection section for detecting a distinguishing symbol for distinguishing a data section and a non-data section of the transmission signal from each other based on a change pattern of signal levels of the transmission signal;
a data determination section for reproducing data from the data section of the transmission signal based on a detection result of the distinguishing symbol detection section; and
a non-data determination section for reproducing non-data information from the non-data section of the transmission signal based on the detection result of the distinguishing symbol detection section;
wherein when a signal level of a symbol in the transmission signal and a signal level of an immediately previous symbol thereto have the same higher/lower relationship as each other with respect to a reference level, the distinguishing symbol detection section detects the symbol as a distinguishing symbol.

11. A data receiving device according to claim 10, wherein when a signal level of a symbol in the transmission signal is equal to a signal level of an immediately previous symbol thereto, the distinguishing symbol detection section detects the symbol as a distinguishing symbol.

12. A data receiving device according to claim 10, wherein the non-data determination section distinguishes a header type corresponding to the non-data section by determining which of a plurality of patterns of symbol streams prepared in advance in correspondence with header types is included in the non-data section.

13. A data receiving device according to claim 10, further comprising a biphase encoding section for biphase-mark-encoding data which is reproduced by the data determining section and outputting an encoding result as a data section of the frame data, wherein the non-data determination section converts the non-data section into a header section of the frame data in accordance with the pattern of the non-data section of the transmission signal, and outputs the header section.

14. A transmission path encoding method for mapping each symbol of sending data to any one of a plurality of signal levels, the transmission path encoding method comprising the steps of:
mapping a data section such that a higher/lower relationship of a signal level of each symbol with respect to a reference level is constantly inverted on a symbol by symbol basis; and
mapping a non-data section to be transmitted in a state of being distinguished from the data section such that the non-data section includes a distinguishing symbol for distinguishing the data section and the non-data section from each other, and such that a higher/lower relationship of a signal level of the distinguishing symbol with respect to the reference level is the same as the higher/lower relationship of a symbol immediately before the distinguishing symbol.

15. A transmission path encoding method according to claim 14, wherein the mapping is performed such that:
a) when the signal level of the symbol immediately before the distinguishing symbol is higher than the reference level, the signal level of the distinguishing symbol is equal to or higher than the signal level of the symbol immediately before the distinguishing symbol; and
b) when the signal level of the symbol immediately before the distinguishing symbol is lower than the reference level, the signal level of the distinguishing symbol is equal to or lower than the signal level of the symbol immediately before the distinguishing symbol.

16. A transmission path encoding method according to claim 14, wherein the mapping is performed such that the signal level of the distinguishing symbol is equal to the signal level of the symbol immediately before the distinguishing symbol.

17. A decoding method for decoding a receiving signal obtained as a result of mapping performed by a transmission path encoding method according to claim 14, the decoding method comprising the steps of:
detecting the distinguishing symbol included in the receiving signal by determining a higher/lower relationship of the signal level of each symbol with respect to the reference level on a symbol by symbol basis; and
individually decoding the data section and the non-data section based on the distinguishing symbol.

18. A decoding method for decoding a receiving signal obtained as a result of mapping performed by a transmission path encoding method according to claim 15, the decoding method comprising the steps of:
detecting the distinguishing symbol by determining a signal level difference between two consecutive symbols of the data on a symbol by symbol basis;
individually decoding the data section and the non-data section based on the distinguishing symbol.

19. A decoding method for decoding a receiving signal obtained as a result of mapping performed by a transmission path encoding method according to claim 16, the decoding method comprising the steps of:
detecting the distinguishing symbol by determining whether or not two consecutive symbols of the data have an equal signal level;
individually decoding the data section and the non-data section based on the distinguishing symbol.
